(19) United States
(12) Patent Application Publication
(10) Pub. No.: US 2023/0050278 A1
(43) Pub. Date: Feb. 16, 2023

(54) SYSTEMS AND METHODS FOR CONVEYING VIBROTACTILE AND THERMAL SENSATIONS THROUGH A WEARABLE VIBROTHERMAL DISPLAY FOR SOCIO-EMOTIONAL COMMUNICATION

(71) Applicants: Troy McDaniel, Gilbert, AZ (US); Yatiraj Shetty, Tempe, AZ (US); Shubham Gharat, Tempe, AZ (US)

(72) Inventors: Troy McDaniel, Gilbert, AZ (US); Yatiraj Shetty, Tempe, AZ (US); Shubham Gharat, Tempe, AZ (US)

(73) Assignee: Arizona Board of Regents on Behalf of Arizona State University, Tempe, AZ (US)

(21) Appl. No.: 17/818,643

(22) Filed: Aug. 9, 2022

Related U.S. Application Data
(60) Provisional application No. 63/232,778, filed on Aug. 13, 2021.

(51) Int. Cl. G06F 3/01; G06F 1/16

(52) U.S. Cl. CPC G06F 3/016; G06F 1/163

(57) ABSTRACT

Various embodiments of a wearable haptic and thermal feedback display system are disclosed herein. In particular, the system includes an array of vibrotactile actuators and thermal units affixed on a flexible casing that could be worn around the forearm. The collocated vibrotactile and thermal stimulations could enable richer haptic communication due to better control over the generated patterns. In addition, the device could be wirelessly controlled using a smartphone which further proves its applicability in long distance haptic communication

### CROSS-REFERENCE TO RELATED APPLICATIONS

This is a U.S. Non-Provisional patent application that claims benefit to U.S. Provisional Patent Application Ser. No. 63/232,778 filed 13 Aug. 2021, which is herein incorporated by reference in its entirety.

### FIELD

The present disclosure generally relates to haptic devices, and in particular, to a system and associated method for conveying vibrotactile and thermal sensations through a wearable vibrothermal display for socio-emotional communication.

### BACKGROUND

A haptic display renders nuanced touch-based information, either tactile, kinesthetic or both, to users in real, augmented, or virtual environments. One application being investigated for this type of display is haptic exploration of virtual paintings. This technology enables people who are blind or visually impaired to personally experience the style and expressiveness of a visual artist.

Further, haptic displays can be used to communicate with or otherwise provide aid to visual-impaired and/or hearing-impaired individuals. In particular, combinations of alternative methods of expression or communication, such as vibrotactile patterns, thermal patterns, or other types of sensory input, can enhance interpersonal and media experiences for those with sensory impairments.

Haptic displays use various methods to generate vibrotactile inputs such as motors (LRA/ERM), voice coils and ultrasound. Vibrotactile sensations are different from other haptic sensation from other methods like skin deformation, applied pressure or friction. Nevertheless, vibrotactile motors (ERM/LRA) have found application in mainstream consumer electronics (like smartphones and smartwatches) because they are inexpensive and easy to control.

It is with these observations in mind, among others, that various aspects of the present disclosure were conceived and developed.

### BRIEF DESCRIPTION OF THE DRAWINGS

FIG. 1 is a photograph showing a wearable vibrothermal display system;

FIG. 2 is a photograph showing the wearable vibrothermal display system of FIG. 1 on a forearm of the user;

FIG. 3 is a simplified block diagram showing the wearable vibrothermal display system of FIG. 1;

FIG. 4 is a diagram showing an example arrangement of vibrotactile motors (circles) and Peltier units (square) on a surface of the wearable vibrothermal display system of FIG. 1;

FIGS. 5A-5H are a series of diagrams showing a sample of vibrothermal patterns generated by the wearable vibrothermal display system of FIG. 1;

FIGS. 6A and 6B are a pair of diagrams showing temporal activation/deactivation sequences respectively corresponding to FIG. 5A and FIG. 5E;

FIGS. 7A and 7B are schematic views showing one embodiment of the wearable vibrothermal display system of FIG. 1;

FIGS. 8A-8C are illustrations showing alternative embodiments of the wearable vibrothermal display system of FIG. 1;

FIG. 9 is a simplified diagram showing an exemplary computing system for implementation of the wearable vibrothermal display system of FIG. 1; and

FIG. 10 is a process flow diagram showing a method for communicating information to a user by the vibrothermal haptic display device of FIG. 1.

Corresponding reference characters indicate corresponding elements among the view of the drawings. The headings used in the figures do not limit the scope of the claims.

### DETAILED DESCRIPTION

Various embodiments of a vibrothermal haptic display device and associated methods for conveying vibrotactile and thermal sensations through a wearable vibrothermal display for socio-emotional communication are disclosed herein. The vibrothermal haptic display device includes an array of vibrotactile motor units and thermal units on a flexible casing that can be worn on the body such as on an arm. In some embodiments, the vibrothermal haptic display device includes a wearable form factor and can be easily modified per application. In other embodiments, the vibrothermal haptic display device can include a fully covered arm, gloves, bracelets or can be embodied as a layer onto other devices in contact with human skin. In some embodiments, vibrotactile and thermal stimulation from the vibrothermal haptic display device can be dynamically controlled to generate various stimulation patterns including collocated vibrotactile and thermal stimulation patterns. In some embodiments, the vibrothermal haptic display device is configured to respond to wireless-based control of stimulation patterns.

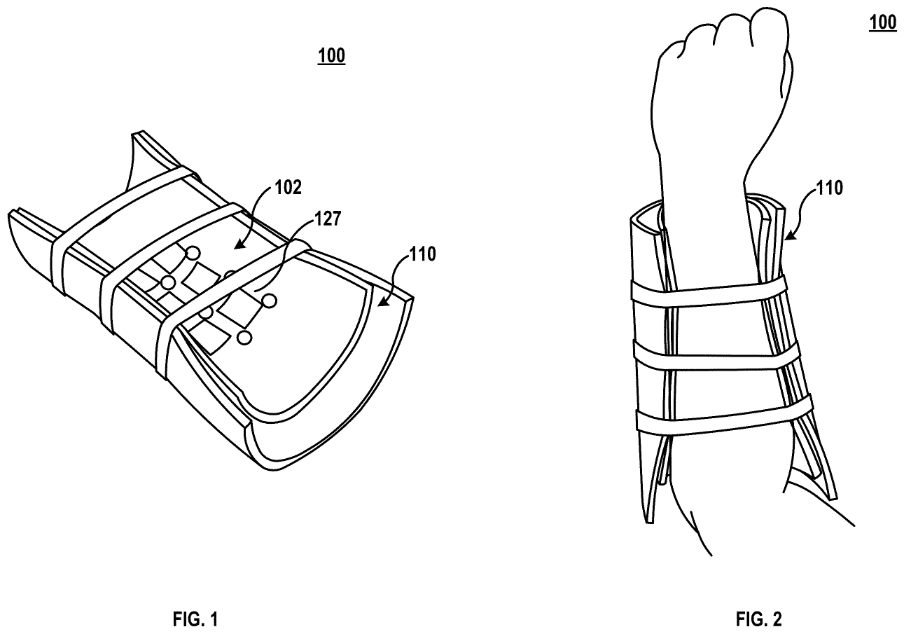

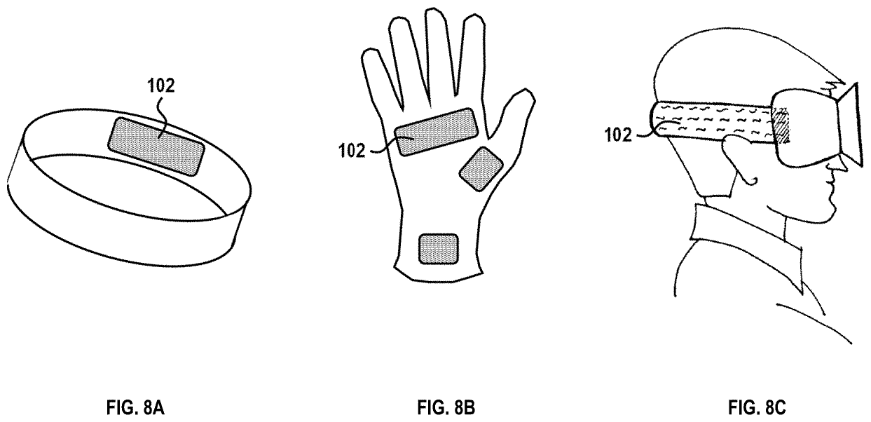

Referring to FIG. 1, a vibrothermal haptic display device 100 is shown including a vibrothermal array 102 mounted within a wearable housing 110 that includes a vibrotactile motor array 124 and a thermal unit array 122. FIG. 2 shows an embodiment of the vibrothermal haptic display device 100 worn by a user on the forearm. In some embodiments, the vibrothermal haptic display device 100 can be embodied within the wearable housing 110 such as an armband, as shown, and can be adjusted to fit varying forearm sizes. In other embodiments, such as the examples shown in FIGS. 8A-8C, the vibrothermal array 102 of the vibrothermal haptic display device 100 can be included within a bracelet or watch or as another wearable article such as a glove. In some embodiments, the vibrothermal array 102 of the vibrothermal haptic display device 100 can be incorporated into an output device from a computer or a gaming console such as a VR headset as shown in FIG. 8C.

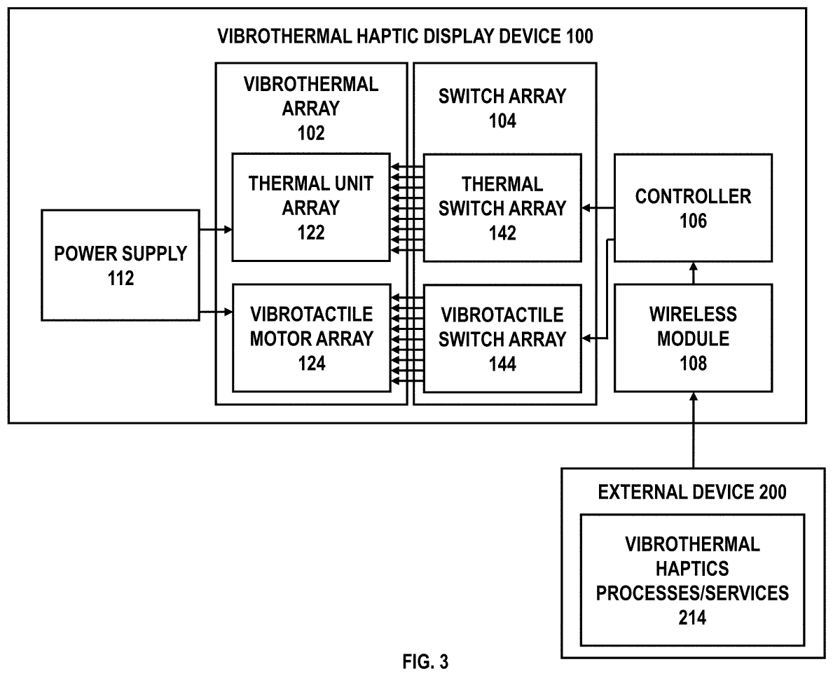

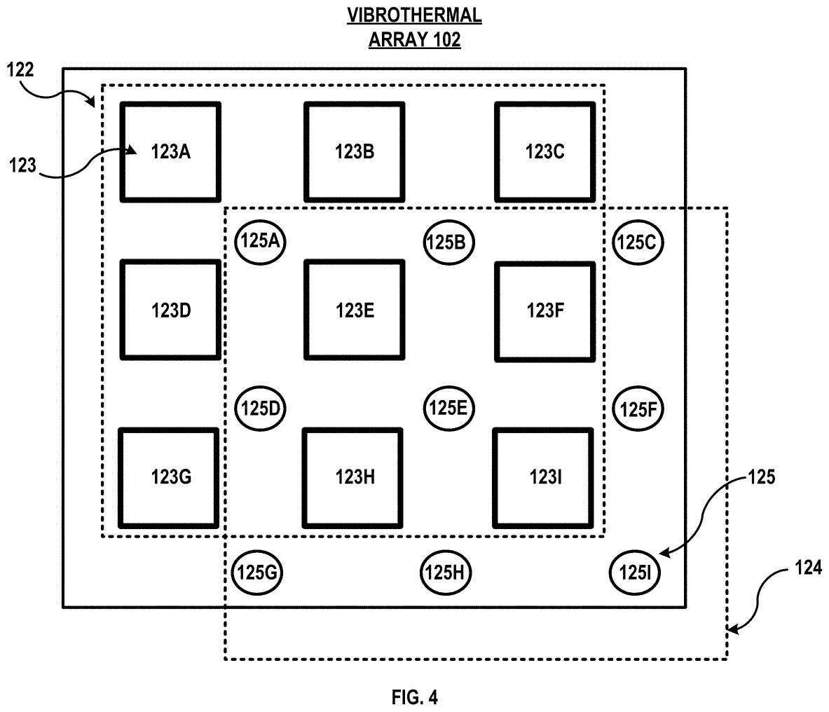

As shown in FIGS. 3-5H, the vibrothermal haptic display device 100 defines the vibrothermal array 102 that includes the thermal unit array 122 and the vibrotactile motor array 124 for applying various vibrothermal stimulation patterns to the skin. The vibrothermal array 102 is associated with a contact surface 127 of the wearable housing 110 that contacts the skin of the wearer and applies the various vibrothermal stimulation patterns using the thermal unit array 122 and the vibrotactile motor array 124. The thermal unit array 122 includes a plurality of thermal units 123; in some embodiments, each thermal unit 123 of the plurality of thermal units 123 is a Peltier unit or is otherwise configured to heat up or cool down according to a signal received at the thermal unit 123. Peltier units can provide hot or cold temperatures on a particular side depending on the direction of the current passed through it. The vibrotactile motor array 124 includes a plurality of vibrotactile motor units 125; in some embodiments, each vibrotactile motor unit 125 is an Eccentric Rotating Mass vibration motor (ERM). The temperature changes in the thermal unit 123 and the vibrations in the vibrotactile motor units 125 that collectively apply the vibrothermal stimulation pattern are controlled by a controller 106. FIG. 4 shows an example arrangement of thermal units 123A-123I and vibrotactile motor units 125A-125I of the vibrothermal array 102 implemented with the vibrothermal haptic display device 100. In some embodiments, each thermal unit 123 is a ceramic Peltier unit of size 20 mm*20 mm*5.1 mm, and each vibrotactile motor unit 125 of 8 mm diameter are arranged in 3×3 matrix staggered with respect to one another, as illustrated. In some embodiments, the vibrothermal array 102 can cover a size of 10 cm×10 cm on the user's skin. The overall surface of the skin affected by the thermal units 123 and the vibrotactile motor units 125 are in different locations but in close proximity to one another. This arrangement was found beneficial when controlling the vibrothermal haptic display device 100 in thermal and vibrotactile modalities individually or simultaneously (vibrothermal modality).

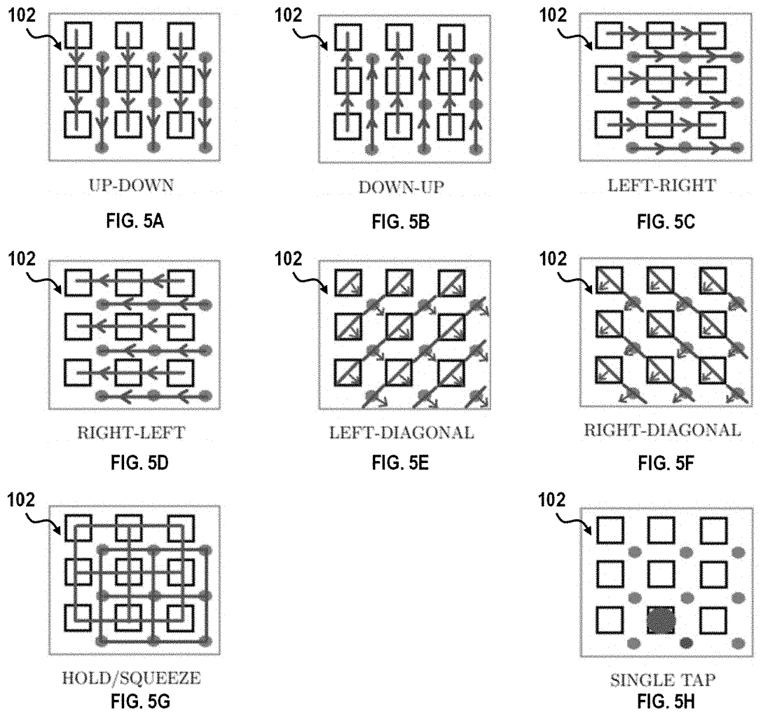

FIGS. 5A-5H show various vibrothermal patterns generated with the vibrothermal haptic display device 100. The blue markings indicate vibrational directional patterns and the red markings indicate thermal directional patterns of various vibrothermal stimulation patterns that can be used to communicate information to a wearer. The vibrothermal array 102 can be controlled in its modality and when the thermal unit array 122 and the vibrotactile motor array 124 are controlled together, the vibrothermal array 102 generates various vibrothermal stimulation patterns.

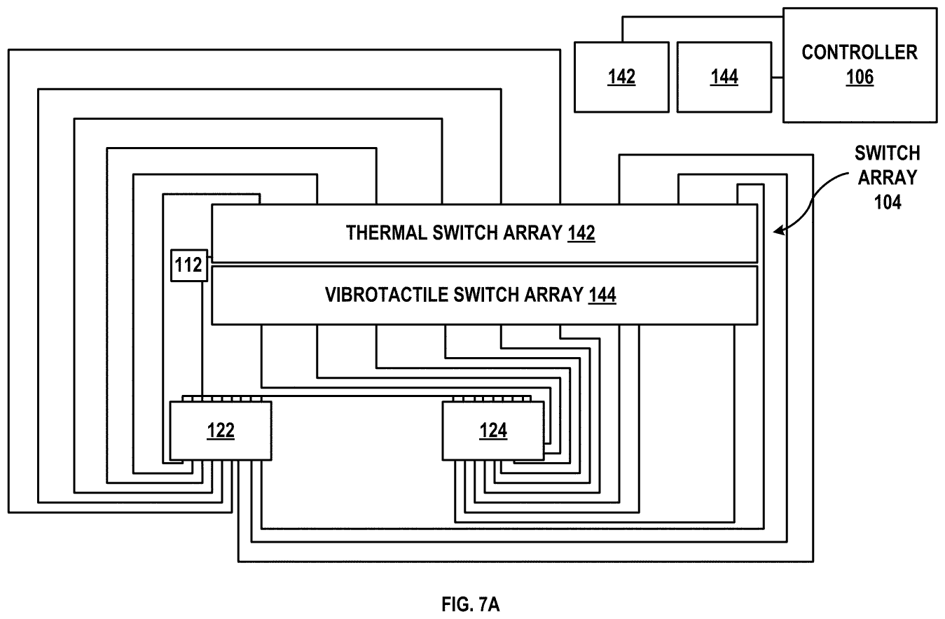

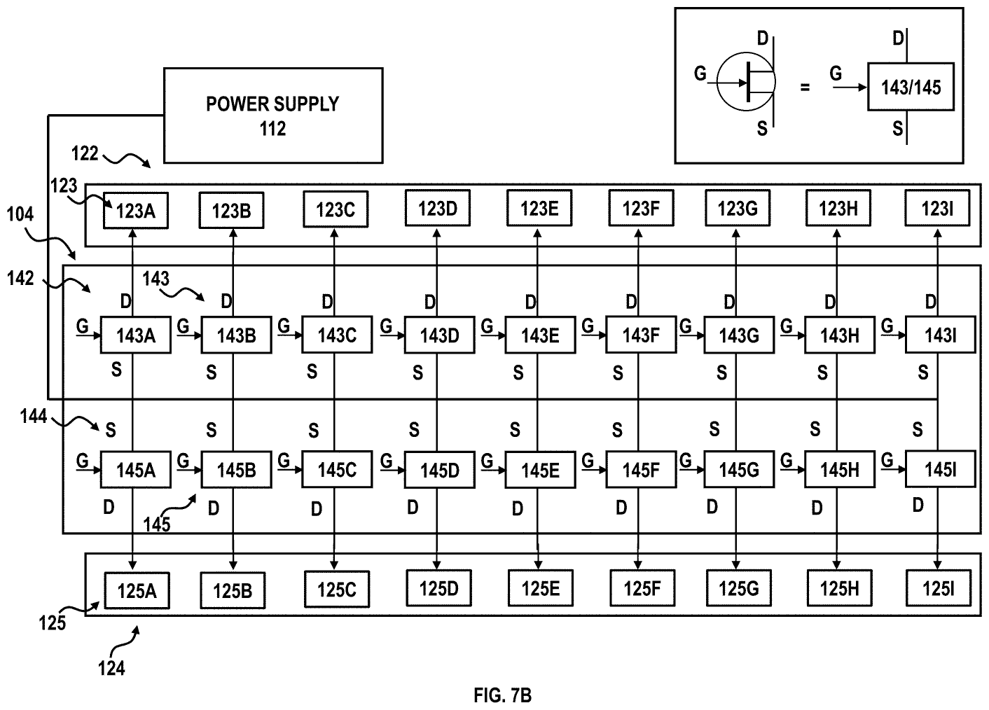

Referring to FIGS. 3-7B, the vibrothermal haptic display device 100 controls the vibrotactile motor array 124 by a switch array 104 in communication with a controller 106 that in some embodiments is configured to receive operating instructions from an external computing device 200 such as a smartphone or another external computing device. The controller 106 receives input from the external computing device 200 including a vibrothermal stimulation pattern and sends control signals to the switch array 104 indicative of the vibrothermal stimulation pattern to be applied at the vibrothermal array 102. The switch array 104 is divided into two sub-arrays for controlling each thermal unit 123 and vibrotactile motor unit 125 from the controller 106 including a thermal switch array 142 and a vibrotactile switch array 144. The thermal switch array 142 includes a plurality of thermal switches 143 with each respective thermal switch 143 of the plurality of thermal switches 143 corresponding with a respective thermal unit 123 of the thermal unit array 122 in order to turn the associated thermal unit 123 on or off according to a desired thermal directional pattern. Similarly, the vibrotactile switch array 144 includes a plurality of vibrotactile switches 145 with each vibrotactile switch 145 of the plurality of vibrotactile switches 145 corresponding with a respective vibrotactile motor unit 125 of the vibrotactile motor unit array 124 in order to turn the associated vibrotactile motor unit 125 on or off according to a desired vibrational directional pattern. In some embodiments, each thermal switch 143 or vibrotactile switch 145 of the switch array 104 can be a MOSFET with each gate operatively connected to the controller 106 as illustrated in FIG. 7B. In the embodiment of FIGS. 4 and 7B, each thermal unit 123A-123I is controlled by a respective thermal switch 143A-143I, and each vibrotactile motor unit 125A-125I is controlled by a respective vibrotactile switch 145A-145I. The switch array 104 actuates the vibrothermal array 102 according to the vibrothermal stimulation pattern from the controller 106. In some embodiments, the vibrothermal haptic display device 100 includes a wireless module 108 such as a Bluetooth module (HC-05), a Wi-Fi module, or other suitable wireless connection for facilitating communication between the controller 106 and the external computing device 200.

With reference to FIGS. 5A-5H, the vibrothermal haptic display device 100 applies various vibrothermal stimulation patterns based on a vibrothermal pattern selection provided at the controller 106, which can in turn be controlled by the external computing device 200. The vibrothermal stimulation patterns can be defined in terms of a temporal sequence (e.g., a vibrothermal stimulation pattern applied across a plurality of time steps) in which the switch array 104 activates or deactivates each thermal unit 123 and vibrotactile motor unit 125 of the vibrothermal array 102 according to the temporal sequence. For the purposes of this disclosure, a vibrothermal stimulation pattern can include a plurality of time steps; a vibrothermal stimulation pattern sequence can be defined as a temporal sequence of one or more vibrothermal stimulation patterns to be applied, including repeating cycles of a single vibrothermal stimulation pattern and also including piece-wise combinations of one or more vibrothermal stimulation patterns.

For instance, with reference to FIG. 5A, a first “up-down” vibrothermal stimulation pattern is shown with respect to the vibrothermal array 102 of FIG. 4. The vibrothermal array 102 of FIG. 4 can be divided into rows, with a first row having thermal units 123A-123C and vibrotactile motor units 125A-125C at the “top” of the vibrothermal array 102, a second row having thermal units 123D-123F and vibrotactile motor units 125D-125F along the “middle” of the vibrothermal array 102, and a third row of thermal units 123G-123I and vibrotactile motor units 125G-125I along the “bottom” of the vibrothermal array 102. Note that the vibrothermal array 102 can include any number of rows and/or any arrangement of thermal units 123 or vibrotactile motor units 125.

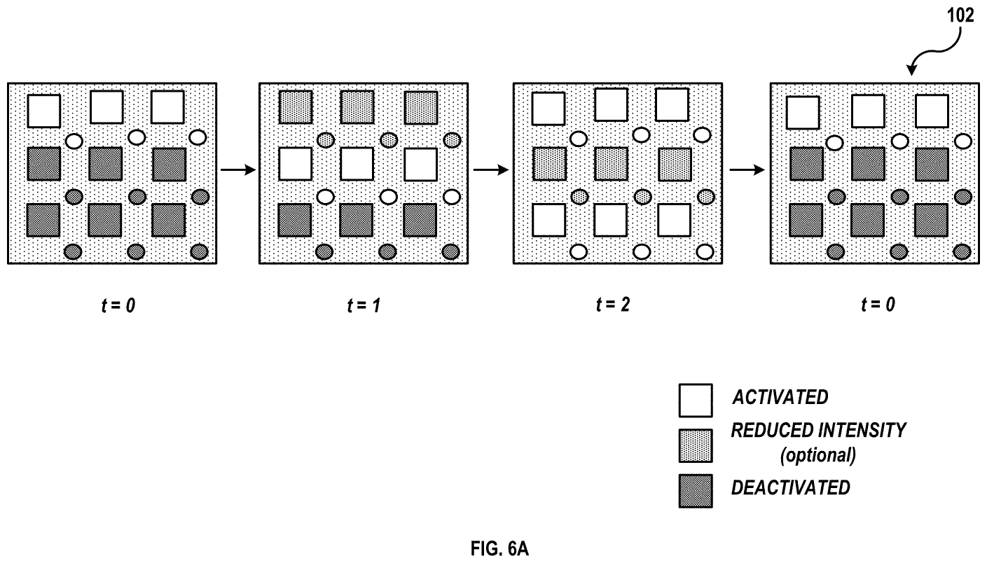

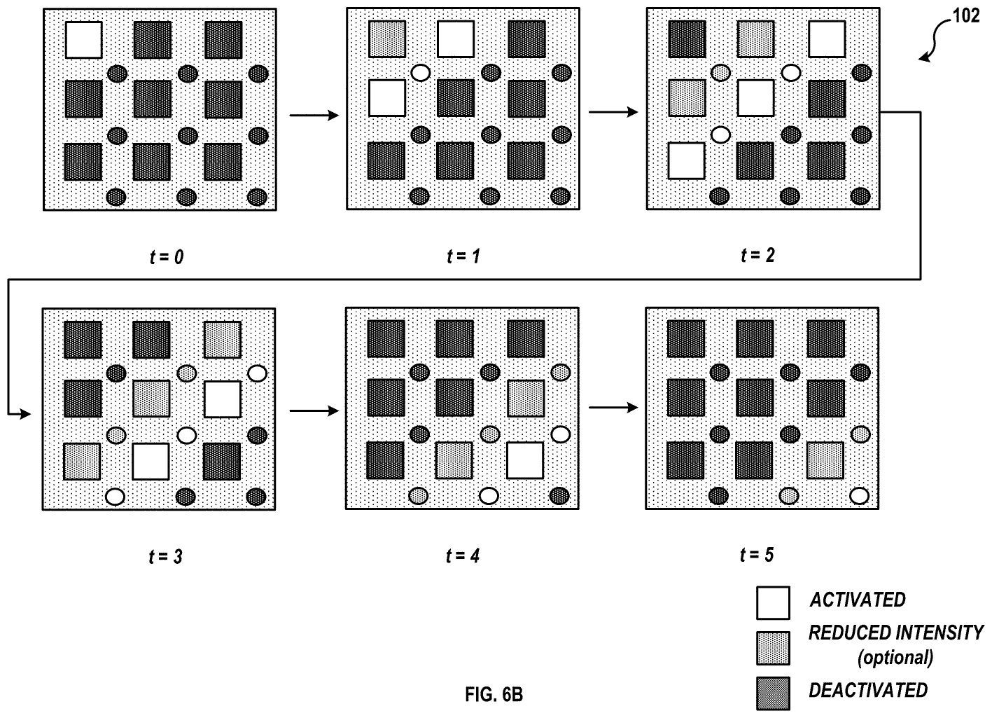

The vibrothermal stimulation pattern can be defined in terms of a temporal sequence having a plurality of time steps in which each respective thermal unit 123 and vibrotactile motor unit 125 is assigned an activation state. One example temporal sequence is shown in FIG. 6A and corresponds with the first “up-down” vibrothermal stimulation pattern of FIG. 5A.

For example, for the first “up-down” vibrothermal stimulation pattern of FIG. 5A and with additional reference to FIG. 6A, consider a first temporal sequence having a first time step at time t=0, a second time step at time t=1, and a third time step at time t=2. At the first time step (where time t=0), the controller 106 can instruct the first row including thermal units 123A-123C and vibrotactile motor units 125A-125C at the “top” of the vibrothermal array 102 to activate.

At the second time step (where time t=1), the controller 106 can instruct the second row including thermal units 123D-123F and vibrotactile motor units 125D-125F along the “middle” of the vibrothermal array 102 to activate. Optionally, during the second time step, the controller 106 can instruct the first row including thermal units 123A-123C and vibrotactile motor units 125A-125C along the “top” of the vibrothermal array 102 to deactivate completely or to reduce intensity based on application or use case.

At the third time step (where time t=2), the controller 106 can instruct the third row including thermal units 123G-123I and vibrotactile motor units 125G-125I along the “bottom” of the vibrothermal array 102 to activate. Optionally, during the third time step, the controller 106 can instruct the second row including thermal units 123D-123F and vibrotactile motor units 125D-125F along the “middle” of the vibrothermal array 102 to deactivate or to reduce intensity, and can also instruct the first row including thermal units 123A-123C and vibrotactile motor units 125A-125C at the “top” of the vibrothermal array 102 to deactivate completely.

A temporal sequence applied by the vibrothermal array 102 can include any number of time steps as is appropriate to convey the vibrothermal stimulation pattern; for this example, the first temporal sequence with respect to FIG. 5A can end at the third time step. If the information received at the controller 106 permits, the first temporal sequence can start again at the first time step at time t=0 and can repeat until the controller 106 receives a control input indicating a new pattern to be applied and/or receives a control input that causes the controller 106 to cease application of the vibrothermal stimulation pattern.

Similarly, with respect to FIG. 5B, a second “down-up” vibrothermal stimulation pattern applied by the vibrothermal array 102 can be reversed with respect to the first “up-down” vibrothermal stimulation pattern of FIG. 5A, with the third row being activated at the first time step and the first row being activated at the third time step.

In another example corresponding to FIG. 5C, a third “left-right” vibrothermal stimulation pattern applied by the vibrothermal array 102 is shown in which the vibrothermal array 102 of FIG. 4 is divided into columns; namely, a first column on the left-hand side can include thermal units 123A, 123D and 123G and vibrotactile motor units 125A, 125D and 125G, a second column down the middle can include thermal units 123B, 123E and 123H and vibrotactile motor units 125B, 125E and 125H, and a third column on the right-hand side can include thermal units 123C, 123F and 123I and vibrotactile motor units 125C, 125F and 125I.

Consider a third temporal sequence corresponding to FIG. 5C having a first time step at time t=0, a second time step at time t=1, and a third time step at time t=2. At the first time step (where time t=0), the controller 106 can instruct the first column of the vibrothermal array 102 to activate. At the second time step (where time t=1), the controller 106 can instruct the second column of the vibrothermal array 102 to activate. Optionally, during the second time step, the controller 106 can instruct the first column to deactivate or to reduce intensity. At the third time step (where time t=2), the controller 106 can instruct the third column of the vibrothermal array 102 to activate. Optionally, during the third time step, the controller 106 can instruct the second column to deactivate or to reduce intensity, and can also instruct the first column to deactivate completely.

Similarly, with respect to FIG. 5D, a fourth “right-left” vibrothermal stimulation pattern applied by the vibrothermal array 102 can be reversed with respect to the third “left-right” vibrothermal stimulation pattern of FIG. 5C, with the third column being activated at the first time step and the first column being activated at the third time step.

In some embodiments, with respect to FIGS. 5E and 5F, the vibrothermal stimulation pattern can be applied within a temporal sequence along “diagonals” of the vibrothermal array 102.

Referring to FIG. 5E, a fifth “left-diagonal” vibrothermal stimulation pattern applied by the vibrothermal array 102 is shown in which the vibrothermal array 102 of FIG. 4 is divided into diagonals starting at the upper left corner. In the example shown, a first diagonal can include thermal unit 123A, a second diagonal can include thermal units 123B and 123D and vibrotactile motor unit 125A, a third diagonal can include thermal units 123C, 123E, and 123G and vibrotactile motor units 125B and 125D, a fourth diagonal can include thermal units 123F and 123H and vibrotactile motor units 125C, 125E and 125G, a fifth diagonal can include thermal unit 123I and vibrotactile motor units 125F and 125H, and a sixth diagonal can include vibrotactile motor unit 125I.

FIG. 6B shows a fifth temporal sequence corresponding to FIG. 5E having a first time step at time t=0, a second time step at time t=1, a third time step at time t=2, a fourth time step at time t=3, a fifth time step at time t=4 and a sixth time step at time t=5. At the first time step (where time t=0), the controller 106 can instruct the first diagonal of the vibrothermal array 102 to activate. At the second time step (where time t=1), the controller 106 can instruct the second diagonal of the vibrothermal array 102 to activate. Optionally, during the second time step, the controller 106 can instruct the first diagonal to deactivate or to reduce intensity. At the third time step (where time t=2), the controller 106 can instruct the third diagonal of the vibrothermal array 102 to activate. Optionally, during the third time step, the controller 106 can instruct the second diagonal to deactivate or to reduce intensity, and can also instruct the first diagonal to deactivate completely. Continuing with this pattern, at the fourth time step (where time t=3), the controller 106 can instruct the fourth diagonal of the vibrothermal array 102 to activate. Similarly, at the fourth time step, the controller 106 can instruct the third diagonal to deactivate or to reduce intensity, and can also instruct the second diagonal to deactivate completely. At the fifth time step (where time t=4), the controller 106 can instruct the fifth diagonal of the vibrothermal array 102 to activate. Similarly, at the fifth time step, the controller 106 can instruct the fourth diagonal to deactivate or to reduce intensity, and can also instruct the third diagonal to deactivate completely. At the sixth time step (where time t=5), the controller 106 can instruct the sixth diagonal of the vibrothermal array 102 to activate. Similarly, at the sixth time step, the controller 106 can instruct the fifth diagonal to deactivate or to reduce intensity, and can also instruct the fourth diagonal to deactivate completely. In some embodiments, two or more diagonals can be activated at a time in an alternating fashion to provide a multi-layered effect.

Similarly, with respect to FIG. 5F, a sixth “right-diagonal” vibrothermal stimulation pattern applied by the vibrothermal array 102 can be reflected with respect to the fifth “left-diagonal” vibrothermal stimulation pattern of FIG. 5E, with a first diagonal including the thermal unit 123C and the vibrotactile motor unit 125C being activated at a first time step (where t=0) and with a final fifth diagonal including the thermal unit 123G and the vibrotactile motor unit 125G being activated at a fifth time step (where t=4).

Other vibrothermal stimulation pattern options are shown in FIGS. 5G and 5H. With respect to a seventh vibrothermal stimulation pattern of FIG. 5G, one or more thermal units 123 can be grouped together in a first grouping and one or more vibrotactile motor units 125 can be similarly grouped together in a second grouping to be actuated together or in an alternating fashion. The vibrothermal stimulation pattern can include any number of time steps, with selected thermal units 123 and vibrotactile motor units 125 being activated in an alternating fashion or together in a “hold” pattern or a “squeeze” pattern (e.g., a pulse). With respect to an eighth vibrothermal stimulation pattern of FIG. 5H, a “single tap” pattern is shown in which a single thermal unit 123 and a single vibrotactile motor unit 125 are activated at a time.

Note that while the aforementioned vibrothermal stimulation patterns are shown in an isolated fashion, any combination of the vibrothermal stimulation pattern options of FIGS. 5A-5H can be applied within a temporal sequence, including sequentially or in a piecewise manner. For instance, the controller 106 can apply a control signal to the switch array 104 that causes the switch array 104 to divide the thermal units 123A-123I and the vibrotactile motor units 125A-125I as needed in order to apply a particular combination of vibrothermal stimulation patterns. Further, other vibrothermal stimulation patterns are contemplated, including but not limited to radial patterns (e.g., one or more “outer” rings and one or more “inner” rings that activate), checkerboard patterns, and other divisions.

For instance, the controller 106 can apply a control signal to the switch array 104 that causes the vibrothermal array 102 to simultaneously exhibit more than one vibrothermal stimulation pattern. In one example, the controller 106 can apply a control signal to the switch array 104 that causes the vibrothermal array 102 to exhibit the first “up-down” vibrothermal stimulation pattern along a first portion of the vibrothermal array 102 while simultaneously exhibiting the sixth “single tap” vibrothermal stimulation pattern along a second portion of the vibrothermal array 102.

In another example, the controller 106 can receive control signals that eventually cause the vibrothermal array 102 to exhibit a vibrothermal stimulation pattern sequence, which can include one or more vibrothermal stimulation patterns to be applied in a sequential order. For example, the controller 106 can apply a control signal to the vibrothermal array 102 that causes the vibrothermal array 102 to exhibit the first “up-down” vibrothermal stimulation pattern of FIG. 5A and the second “down-up” vibrothermal stimulation pattern of FIG. 5B in an alternating fashion. As such, one or more control signals received at the controller 106 can cause the vibrothermal array 102 to apply a vibrothermal stimulation pattern sequence over a plurality of time steps. For instance, an example vibrothermal stimulation pattern sequence can include one iteration of a first vibrothermal stimulation pattern, followed by two iterations of a second vibrothermal stimulation pattern, followed by one iteration of a third vibrothermal stimulation pattern, repeat, etc. In a further (non-limiting) example, a vibrothermal stimulation pattern sequence can include a final segment requiring the controller 106 to apply a control signal to the vibrothermal array 102 that causes the vibrothermal array 102 to exhibit the seventh “hold/squeeze” vibrothermal stimulation pattern of FIG. 5G to indicate an end of the temporal sequence and/or to convey other information.

As such, the controller 106 can be configured to sequentially apply control signals to the vibrothermal array 102 to apply complex vibrothermal stimulation patterns as needed. In some embodiments, the vibrothermal stimulation patterns and/or sequences can be pre-defined by the controller 106 such that a control input from the external computing device 200 need only include an indicator of the information to be conveyed. In another aspect, the controller 106 can receive control inputs from the external computing device 200 that indicate more specific instructions about the vibrothermal stimulation pattern and/or vibrothermal stimulation pattern sequence to be applied such as number of iterations, time periods, frequencies (e.g., rapid or slow), groupings of thermal units 123 and vibrotactile motor units 125 within the vibrothermal array 102 (e.g., by column, by row, radial groupings, etc.) and the temporal sequence in which the vibrothermal stimulation patterns are to be applied (e.g., one iteration of a first vibrothermal stimulation pattern, followed by two iterations of a second vibrothermal stimulation pattern, followed by one iteration of a third vibrothermal stimulation pattern, repeat, etc.). Further, in some embodiments, additional information can be conveyed through the vibrothermal array 102 through both cold and warm temperatures. The plurality of thermal units 123 can be configured such that one or more thermal units 123 of the plurality of thermal units 123 apply warm temperatures and one or more thermal units 123 of the plurality of thermal units 123 apply cold temperatures. The switch array 104 can be configured to supply current through the thermal units 123 in a first direction or a second direction, causing the thermal units 123 to become warm or cold as needed; as such, the vibrothermal stimulation pattern sequence can incorporate varying temperatures applied at the vibrothermal array 102 into the vibrothermal stimulation patterns. The vibrothermal stimulation pattern sequence applied at the vibrothermal array 102 can be application-specific such that the information represented by the vibrothermal stimulation pattern sequence through the vibrothermal haptic display device 100 is relevant and understandable to the user for the specific communication purpose.

In one method, the controller 106 receives a control input from the external computing device 200 indicative of a vibrothermal stimulation pattern and/or vibrothermal stimulation pattern sequence to be applied, which can include temporal information about the vibrothermal stimulation pattern or vibrothermal stimulation pattern sequence (e.g., periodicity, number of time steps, repetitions, ordering, etc.) and information about the vibrothermal stimulation patterns to be applied through selected thermal units 123 and vibrotactile motor units 125 of the vibrothermal array 102 (including but not limited to activation states of each respective thermal unit 123 and vibrotactile motor unit 125 within the vibrothermal array 102, intensities, temperatures (if applicable), selected groupings, etc.). The controller 106 can configure the switch array 104 according to the vibrothermal stimulation pattern sequence and apply the vibrothermal stimulation pattern sequence as required by the external computing device 200, where the switch array 104 activates or deactivates thermal units 123 and vibrotactile motor units 125 according to their assigned activation states across one or more time steps (and in some embodiments, the switch array 104 can control a direction of current applied through the thermal units 123 to modulate a temperature applied at the thermal units 123). The controller 106 can then await further instructions from the external computing device 200 for a new vibrothermal stimulation pattern sequence to be applied or to turn off the vibrothermal haptic display device 100.

Referring to FIGS. 3, 8A-8C and 9, the external computing device 200 can include a memory 240 that includes an application such as vibrothermal haptics processes/services 214 and a processor 220 in communication with the controller 106 of the vibrothermal haptic display device 100 that executes the vibrothermal haptics processes/services 214. Vibrothermal haptics processes/services 214 enable the external device to instruct the controller 106 to actuate thermal switches 143 or vibrotactile switches 145 of the switch array 104 according to the vibrothermal stimulation pattern. In some embodiments, the external computing device 200 is a mobile device such as a smartphone, laptop, or tablet and can include one or more applications that interface with vibrothermal haptics processes/services 214. In another embodiment, the external computing device 200 is a video game console or computing system that runs one or more gaming applications that interface with vibrothermal haptics processes/services 214. In some embodiments the vibrothermal haptics processes/services 214 can include a user interface to control and generate different pre-defined and user-defined patterns to the vibrothermal haptic display device 100.

FIGS. 7A and 7B show one embodiment of the vibrothermal haptic display device 100. Control signals from the controller 106 for each thermal unit 123 and vibrotactile motor unit 125 of the vibrothermal array 102 are each passed to the switch array 104 that controls activation or deactivation of each respective thermal unit 123 or vibrotactile motor unit 125 of the vibrothermal array 102. In the embodiment shown, each thermal switch 143 and vibrotactile switch 145 is individually embodied as an N-channel MOSFET, however other suitable electronic switching devices, including but not limited to, P-channel MOSFETS, bipolar junction transistors (BJTs), or optical transistors can be used. In particular, the controller 106 is operable to communicate a control signal to a gate terminal (“G” in FIG. 7B) of a thermal switch 143 or vibrotactile switch 145. The thermal switch 143 or vibrotactile switch 145 and the control signal from the controller 106 are configured to allow or prevent passage of electric current from a first terminal (e.g., a source terminal “S” in FIG. 7B) of the thermal switch 143 or vibrotactile switch 145 to a second terminal (e.g., a drain terminal “D” in FIG. 7B) of the thermal switch 143 or vibrotactile switch 145 and through to a corresponding thermal unit 123 or vibrotactile motor unit 125. The controller 106 individually controls each thermal switch 143 or vibrotactile switch 145 of the switch array 104 to actuate the corresponding thermal unit 123 or vibrotactile motor unit 125.

As mentioned above, Peltier units can provide hot or cold temperatures on a particular side depending on the direction of the current passed through it. For one embodiment of the vibrothermal haptic display device 100, to generate warm temperatures, a first terminal of each thermal unit 123 of the plurality of thermal units 123 is connected to an output terminal of the respective thermal switch 143; in particular, the drain of the thermal switch 143 as shown in the configuration of FIG. 7B using N-channel transistors. A second terminal of each thermal unit 123 of the plurality of thermal units 123 is connected to the ground terminal of a 5V power supply such as power supply 112. In one particular embodiment, an Arduino Nano was used as power supply 112, however note that the power supply 112 can include other power supplies such as a battery bank. Separating the power supply 112 from the controller 106 eliminates problems that may arise due to current drawn by the vibrothermal array 102. If vibrothermal array 102 is connected to the same power source to that of the wireless module 108, the current drawn by the vibrothermal array 102 can cause faults in the Bluetooth communication. In some embodiments, a first terminal of each vibrotactile motor unit 125 can be connected to the power supply 112 and a second terminal can be connected to an output terminal of the respective vibrotactile switch 145; in particular, the drain of the vibrotactile switch 145 as shown in the configuration of FIG. 7B using N-channel transistors. The wireless module 108 can be a Bluetooth module such as a Serial Port Protocol (SPP) module and can be further connected to a TX (transmitter) and RX (Receiver) pin of the controller 106. In some embodiments, the controller 106 is an Arduino Uno. In some embodiments, the plurality of thermal units 123 can be arranged such that one or more thermal units 123 are configured to apply warm temperatures and one or more thermal units 123 are configured to apply cold temperatures. The thermal switch array 142 can be configured to supply current in the appropriate direction through each respective thermal unit 123 of the plurality of thermal units 123 as needed to convey information through warm or cold temperatures. As such, the vibrothermal stimulation pattern applied at the vibrothermal array 102 can include warm and/or cold temperatures.

The vibrothermal haptic display device 100 combines vibrotactile and thermal communication. In addition, the vibrothermal haptic display device 100 has been demonstrated in a flexible form factor and wireless capabilities that add to its functionalities. This is cost effective method to generate rich stimulation patterns that could be used for myriad applications especially in the field of medical devices and consumer electronics. For example:

Communication systems: The most common utility of haptics in daily life is via notification vibrations on our smartphones. There is no device that deals with thermal notifications or messaging. There exists a lack of software application ecosystems to enable this, but the underlying issue is that the smartphones/smartwatches do not have a rich hardware capable of conveying the entire range of haptic sensations.

As shown in the examples of FIGS. 8A and 8B, the vibrothermal array 102 can be integrated into wearables such as a wristband (FIG. 8A) or a glove (FIG. 8B).

Gaming/VR systems: Gaming industry is known for early adoption of cutting-edge technologies. Notwithstanding this, the use of motors to enable real-time vibration stimulation during gaming has only really improved in the last decade. Mainstream devices still do not have thermal feedback modality though it has been known through prior research that thermal stimulation can be effectively used to enhance certain sensations during gameplay. By adding a the vibrothermal array 102 onto gaming controllers or VR headsets such as the VR headset of FIG. 8C, the vibrothermal haptic display device 100 succeeds in improving the realism or experience of the interactions.

Medical devices for therapy: There is great scope for therapeutic haptics to enable better health for a large section of population. This could be done through development of games or training methodologies for emotional regulation, stimulation therapy or even general health. Nevertheless, there is no device in the market that effectively uses both vibrotactile and thermal stimulations to effectively solve domain specific problems.

### Computer-Implemented System

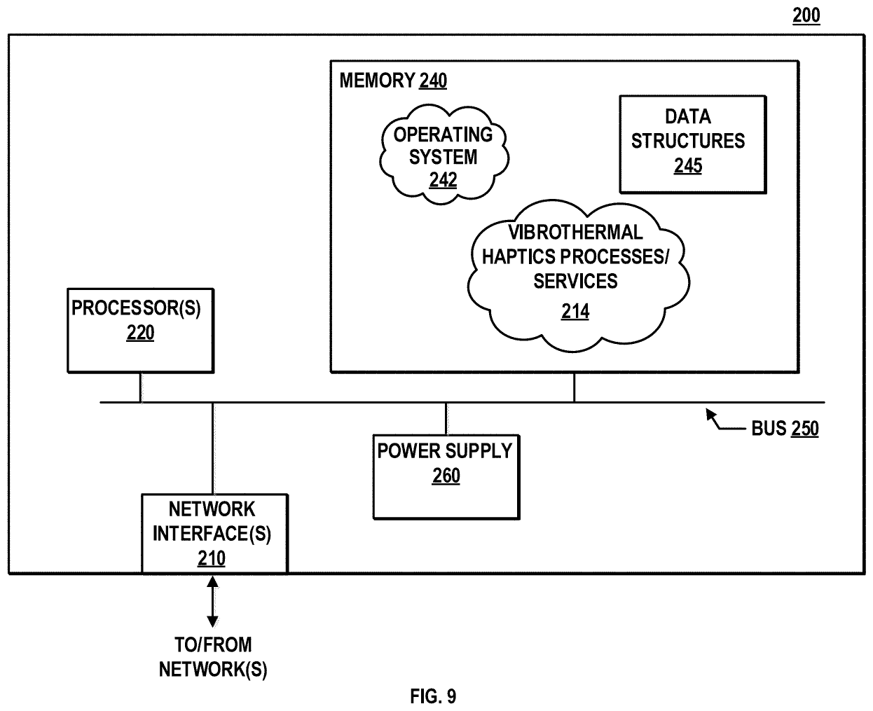

FIG. 9 is a schematic block diagram of an example external computing device 200 that may be used with one or more embodiments described herein, e.g., as a component of the vibrotactile haptic display device 100 and/or as external computing device 200 shown in FIG. 3.

Device 200 comprises one or more network interfaces 210 (e.g., wired, wireless, PLC, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over the communication links coupled to a communication network. Network interfaces 210 are configured to transmit and/or receive data using a variety of different communication protocols. As illustrated, the box representing network interfaces 210 is shown for simplicity, and it is appreciated that such interfaces may represent different types of network connections such as wireless and wired (physical) connections. Network interfaces 210 are shown separately from power supply 260, however it is appreciated that the interfaces that support PLC protocols may communicate through power supply 260 and/or may be an integral component coupled to power supply 260.

Memory 240 includes a plurality of storage locations that are addressable by processor 220 and network interfaces 210 for storing software programs and data structures associated with the embodiments described herein. In some embodiments, device 200 may have limited memory or no memory (e.g., no memory for storage other than for programs/processes operating on the device and associated caches).

Processor 220 comprises hardware elements or logic adapted to execute the software programs (e.g., instructions) and manipulate data structures 245. An operating system 242, portions of which are typically resident in memory 240 and executed by the processor, functionally organizes device 200 by, inter alia, invoking operations in support of software processes and/or services executing on the device. These software processes and/or services may include vibrothermal haptics processes/services 214, described herein. Note that while vibrothermal haptics processes/services 214 is illustrated in centralized memory 240, alternative embodiments provide for the process to be operated within the network interfaces 210, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the vibrothermal haptics processes/services 214 is shown as a standalone process, those skilled in the art will appreciate that this process may be executed as a routine or module within other processes.

### Method

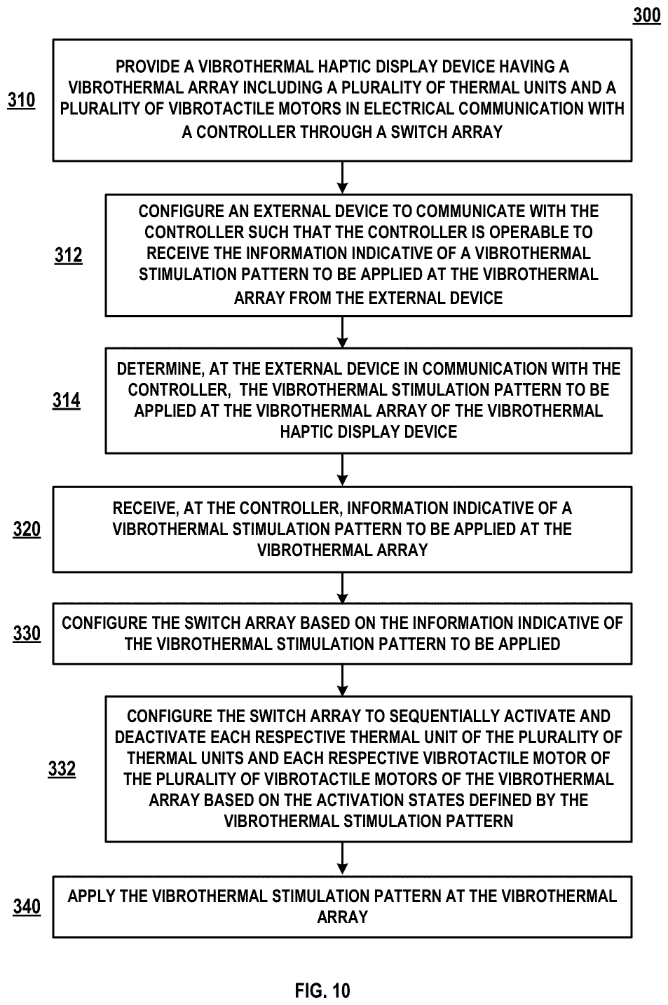

FIG. 10 is a process flow diagram showing a method 300 for communication of information by the vibrothermal haptic display device 100 described herein.

Block 310 of method 300 includes providing a vibrothermal haptic display device having a vibrothermal array including a plurality of thermal units and a plurality of vibrotactile motors in electrical communication with a controller through a switch array. Block 310 can also include various sub-blocks, including block 312 that includes configuring an external device to communicate with the controller such that the controller is operable to receive the information indicative of a vibrothermal stimulation pattern to be applied at the vibrothermal array from the external device, and block 314 that includes determining, at the external device in communication with the controller, the vibrothermal stimulation pattern to be applied at the vibrothermal array of the vibrothermal haptic display device. Block 320 includes receiving, at the controller, information indicative of a vibrothermal stimulation pattern to be applied at the vibrothermal array. Block 330 includes configuring the switch array based on the information indicative of the vibrothermal stimulation pattern to be applied, and can include sub-blocks including block 332 that recites configuring the switch array to sequentially activate and deactivate each respective thermal unit of the plurality of thermal units and each respective vibrotactile motor of the plurality of vibrotactile motors of the vibrothermal array based on the activation states defined by the vibrothermal stimulation pattern. Block 340 includes applying the vibrothermal stimulation pattern at the vibrothermal array. Following block 340, method 300 can start again at block 314 if necessary.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A vibrothermal haptic display device, comprising:
a wearable housing, wherein the wearable housing includes a contact surface;
a vibrothermal array in association with the contact surface of the wearable housing, the vibrothermal array including a thermal unit array and a vibrotactile motor array, wherein the thermal unit array includes a plurality of thermal units and wherein the vibrotactile motor array includes a plurality of vibrotactile motor units; and
a controller in electrical communication with the vibrothermal array, wherein the controller is operable to communicate a plurality of control signals to the vibrothermal array to activate at least one thermal unit of the plurality of thermal units and at least one vibrotactile motor unit of the plurality of vibrotactile motor units according to a vibrothermal stimulation pattern.

2. The vibrothermal haptic display device of claim 1, further comprising:
a switch array in electrical communication with the vibrothermal array and the controller, the switch array including a thermal switch array and a vibrotactile switch array, wherein the thermal switch array includes a plurality of thermal switches and wherein the vibrotactile switch array includes a plurality of vibrotactile switches.

3. The vibrothermal haptic display device of claim 2, wherein each thermal switch of the plurality of thermal switches is associated with a respective thermal unit of the plurality of thermal units, and wherein each vibrotactile switch of the plurality of vibrotactile switches is associated with a respective vibrotactile motor unit.

4. The vibrothermal haptic display device of claim 3, wherein each thermal switch and each vibrotactile switch is a transistor, and wherein a gate of each transistor is in electrical communication with the controller such that a control signal of the plurality of control signals received at the gate of the transistor allows or prevents passage of current from a first terminal of the transistor to a second terminal of the transistor, wherein the first terminal of the transistor is connected to a power supply and wherein the second terminal of the transistor is connected to an associated thermal unit or vibrotactile motor unit.

5. The vibrothermal haptic display device of claim 4, wherein the first terminal is a source terminal of the transistor and wherein the second terminal is a drain terminal of the transistor.

6. The vibrothermal haptic display device of claim 2, wherein the switch array is configured to apply current at a thermal unit of the plurality of thermal units in a first direction or a second direction based on the vibrothermal stimulation pattern such that the thermal unit generates a warm temperature or a cold temperature.

7. The vibrothermal haptic display device of claim 1, wherein the controller is in communication with an external device, wherein the external device is operable to communicate a control signal representative of the vibrothermal stimulation pattern to the controller.

8. The vibrothermal haptic display device of claim 1, wherein the vibrothermal stimulation pattern defines activation states for each respective thermal unit of the plurality of thermal units and each respective vibrotactile motor unit of the plurality of vibrotactile motor units of the vibrothermal array.

9. The vibrothermal haptic display device of claim 1, wherein a vibrothermal stimulation pattern sequence defines activation states for each respective thermal unit of the plurality of thermal units and each respective vibrotactile motor unit of the plurality of vibrotactile motor units of the vibrothermal array over a plurality of time steps.

10. The vibrothermal haptic display device of claim 9, wherein the controller is operable to sequentially activate and deactivate each respective thermal unit of the plurality of thermal units and each respective vibrotactile motor of the plurality of vibrotactile motors of the vibrothermal array over the plurality of time steps based on the vibrothermal stimulation pattern sequence.

11. A method, comprising:
providing a vibrothermal haptic display device having a vibrothermal array including a plurality of thermal units and a plurality of vibrotactile motors in electrical communication with a controller through a switch array;
receiving, at the controller, information indicative of a vibrothermal stimulation pattern to be applied at the vibrothermal array;
configuring the switch array based on the information indicative of the vibrothermal stimulation pattern to be applied; and
applying the vibrothermal stimulation pattern at the vibrothermal array.

12. The method of claim 11, wherein the vibrothermal stimulation pattern defines activation states for each respective thermal unit of the plurality of thermal units and each respective vibrotactile motor of the plurality of vibrotactile motors of the vibrothermal array.

13. The method of claim 11, wherein a vibrothermal stimulation pattern sequence defines activation states for each respective thermal unit of the plurality of thermal units and each respective vibrotactile motor of the plurality of vibrotactile motors of the vibrothermal array over a plurality of time steps.

14. The method of claim 13, wherein the vibrothermal stimulation pattern sequence includes one or more vibrothermal stimulation patterns to be applied at the vibrothermal array over a plurality of time steps.

15. The method of claim 13, further comprising:
configuring the switch array to sequentially activate and deactivate each respective thermal unit of the plurality of thermal units and each respective vibrotactile motor of the plurality of vibrotactile motor units of the vibrothermal array based on the activation states defined by the vibrothermal stimulation pattern.

16. The method of claim 11, further comprising:
determining, at the switch array, a direction of current to be applied at a thermal unit of the plurality of thermal units based on the vibrothermal stimulation pattern such that the thermal unit generates a warm temperature or a cold temperature.

17. The method of claim 11, further comprising:
configuring an external device to communicate with the controller such that the controller is operable to receive the information indicative of a vibrothermal stimulation pattern to be applied at the vibrothermal array from the external device.

18. A system, comprising:
a vibrothermal haptic display device, comprising:
a wearable housing, wherein the wearable housing includes a contact surface;
a vibrothermal array in association with the contact surface of the wearable housing, the vibrothermal array including a thermal unit array and a vibrotactile motor array, wherein the thermal unit array includes a plurality of thermal units and wherein the vibrotactile motor array includes a plurality of vibrotactile motor units; and
a controller in electrical communication with the vibrothermal array, wherein the controller is operable to communicate a plurality of control signals to the vibrothermal array to activate at least one thermal unit of the plurality of thermal units and at least one vibrotactile motor unit of the plurality of vibrotactile motor units according to a vibrothermal stimulation pattern; and
an external computing device including a processor and a memory, the memory including instructions, which, when executed, cause the processor to:
communicate a control signal indicative of the vibrothermal stimulation pattern to the controller of the vibrothermal haptic display device.

19. The system of claim 18, wherein the vibrothermal stimulation pattern defines activation states for each respective thermal unit of the plurality of thermal units and each respective vibrotactile motor unit of the plurality of vibrotactile motor units of the vibrothermal array and wherein the controller is operable to sequentially activate and deactivate each respective thermal unit of the plurality of thermal units and each respective vibrotactile motor unit of the plurality of vibrotactile motor units of the vibrothermal array over a plurality of time steps based on the vibrothermal stimulation pattern.

20. The system of claim 18, wherein the memory of the external computing device further includes instructions, which, when executed, cause the processor of the external computing device to:
determine the vibrothermal stimulation pattern to be applied at the vibrothermal array of the vibrothermal haptic display device.
